(19) United States
(12) Patent Application Publication
(10) Pub. No.: US 2004/0143445 A1
(43) Pub. Date: Jul. 22, 2004

(54) Method of selling controlled items through vending machines

(76) Inventor: Sang K. Sheem, Pleasanton, CA (US)

Correspondence Address: Sang K. Sheem, 1790 Paseo Del Cajon, Pleasanton, CA, 94566, US

(21) Appl. No.: 10/348,660

(22) Filed: Jan. 21, 2003

(51) Int. Cl. G06F 17/60

(52) U.S. Cl. 705/1

(57) ABSTRACT

This invention devises a method to make it feasible for a vending machine to sell controlled items requiring age verification. The controlled items are displayed in a section where customer access is under the control of an attendant in a remote office. In order to generate the expenses for the remote age-verification, the vending operation sells general items as well as controlled items. Also, a plurality of such vending sites are linked to one central monitor office so that the age-verification expenses are shared among many vending sites.

The accessibility may be controlled without the cage by keeping the vending mechanism constantly disabled unless the attendant enables it momentarily.

### NOTE

This invention disclosure is related to a patent application Ser. No. 10/299,502, titled “Means of item-retrieval from a display hook, and methods of using it.”

### TECHNICAL FIELD

This invention relates to vending machines.

### BACKGROUND ART

Laundromats are self-service operated. Gasoline stations have been switched to automated self-service systems during the last couple decades. Such a trend is desirable because it saves operating expenses and offers potential 24-hour service. Similar changeover is desirable in the future of merchandise retail business. At the present, small-scale vending machines are located in the hallways inside buildings.

One niche market for the vending business is apartment complexes and villages. While resale business philosophies has evolved into those of large volume and large scale (i.e. Costco and Wal-Mart), it is also desirable to bring retail services closer to the customers. There would be less traffic on the streets, saving people's time and gasoline. Often a person has to drive a distance to buy a pack of cigarettes.

One drawback of the conventional vending machine merchandising is that they do not carry controlled items, cigarettes in particular, that requires some sort of identification of customers for age verification.

The sales volume and profit of conventional vending machines are far too small to justify the expenses associated with any means of age-verification. The verification requires a substantial amount of electronics and technology. But that is not even the most critical issue. Age verification requires an attendant 24 hours a day and year around, and a dedicated monitoring office. The overall cost could reach up to $10,000 per month, and will far exceed the profit of a typical vending machine merchandise operation. Selling packs of cigarettes would not yield profit even remotely close to the amount.

This invention is to tackle these paramount problems.

### SUMMARY OF THE INVENTION

It is the objective of this patent application to devise a means for selling controlled items such as cigarettes through vending machines without incurring financial loss.

This objective is achieved by making the scale of the vending operation substantially large so that overall sales volume and profit can justify the expense needed for age-verification. The scale would be large enough to make the vending machine operation almost comparable to that of a mini-mart or convenience store.

The controlled items are located in a section that is not accessible unless an attendant, located in a remote central monitor office, makes the controlled items accessible momentarily for a customer.

Non-controlled items are located separately in an open and accessible area, so that people are not inconvenienced when they buy the uncontrolled items.

Furthermore, a plurality of such vending sites are linked to one central monitor office so that the age-verification expenses are shared among many vending sites.

Various means and methods will be described.

### BRIEF DESCRIPTION OF DRAWINGS

FIG. 1 shows a schematic view of one example of a large-scale vending machine with a locked cage for selling controlled items.

FIG. 2 shows a schematic showing a central monitor office which is linked to many vending sites.

### DETAILED DESCRIPTION

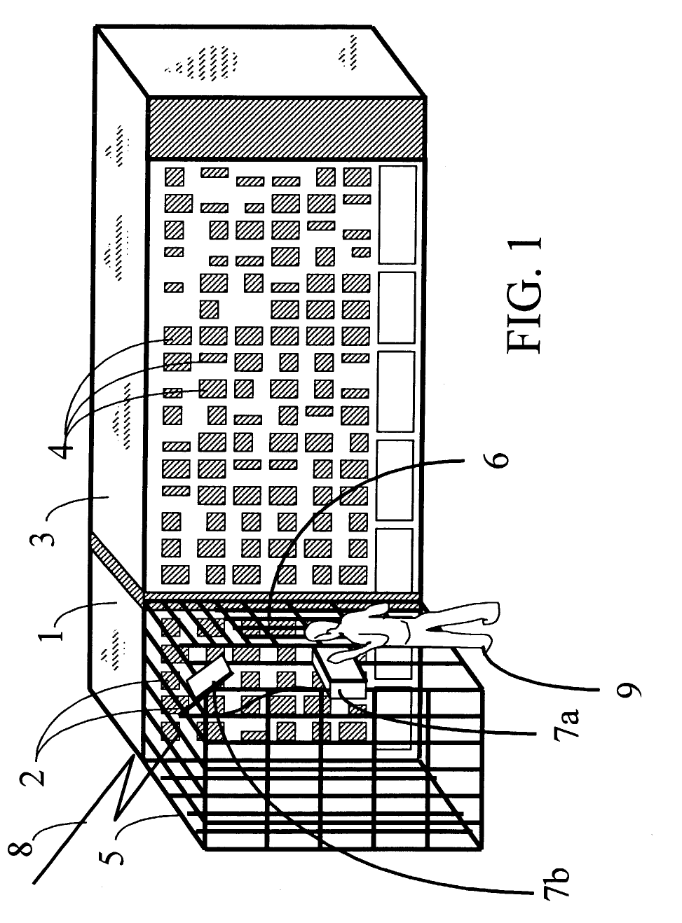

FIG. 1 shows a large-scale vending operation in a schematic fashion. Even though it shows one large machine, there can be many smaller-sized vending machines. The point is that the operation scale should be large enough to make the total gross sales substantial.

Conventional vending machines sell up to 80 different items. They sell only one or two types of products, usually soda, candies, or chips. Such operations will not be able to cover even a small portion of the age-verification expenses.

In FIG. 1, the section 1 containing controlled items 2 requiring age-verification has a cage 5 with a locked door 6 over it.

The section 3 is not caged, and is open. This free-access section carries many items 4. The items could include medicine, tissue paper, diapers, batteries, canned food, detergent, soda, fruit drinks, candies, chips, milk, bread, toothpaste, floss, cooking oil, charcoal, etc. It may not be able to carry over 1,000 items as in a typical convenience store, but needs to sell unusually many items in order to support the expenses associated with the age-verification for the caged section 1.

Even if the vending area carries unusually many items, the sales volume will not be able to support the expenses involved with the remote age-verification. The expenses include labor cost for 24 hours a day and 365 days a year, equipment costs of each site and also the central monitoring office, and rental cost for the central monitor office. The monthly expenses alone would be around $8,000, if not more.

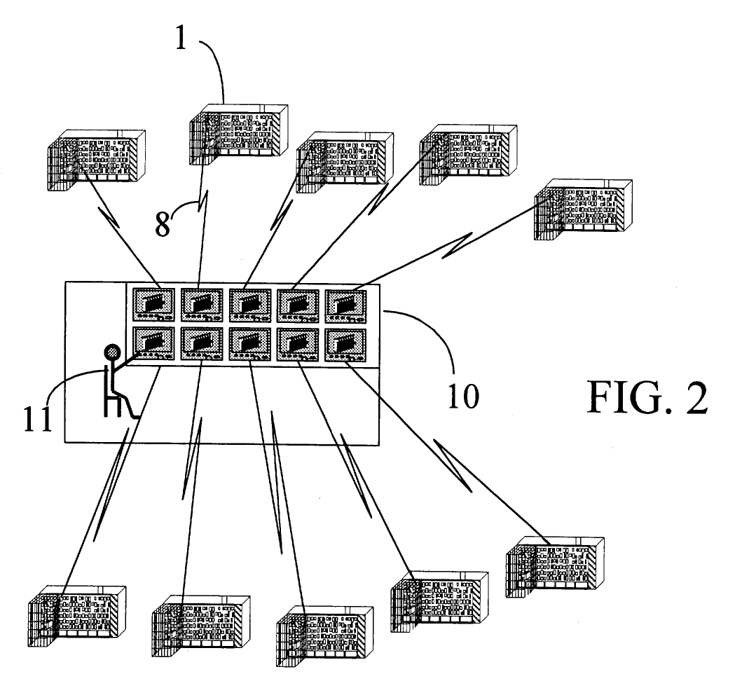

Accordingly, it is necessary to form a group out of many vending sites, and monitor the entire group from one monitor office 10, as depicted in FIG. 2. If there are 20 sites assigned to the attendant 11, the expenses for each vending site will be 1/20 of the total. Assuming a monthly expense of $8,000 for keeping an attendant 24 hours a day in a rented office, the expense for each site is $400 per month, or about $13 per day, in this group arrangement.

This amount still is not a trivial amount for a vending site, but could be an economically feasible amount.

The caged section 2 is equipped with a two way communication link 8 that carries the image of an identification card with the birthday information, as captured on a camera 7a, and the image of the customer 9 himself, as captured by a camera 7b, from the vending site to the central monitor office 10.

The link 8 also carries a ‘Requesting Signal’, which is generated by a customer. The signal may be generated by pushing a button located near the cage door 6, for instance. The signal is transmitted to the attendant 11. The attendant 11 looks at the image of the customer 9. If he looks old enough, such as over 30 or 40 years of age, he unlocks the cage lock through the communication link.

If the age is in doubt, the attendant 11 asks the customer 9 place his drive license on the designated place so that the image appears on the monitor in front of the attendant 11. If the customer 9 is old enough, the attendant 11 unlocks the cage door 6 through the communication link 8.

The first camera 7a and the second camera 7b may be the one and the same.

The access to the controlled items may be controlled even without the cage 5. The vending mechanism may remain disabled in the controlled item section 1, unless the attendant 11 enables the vending mechanism through the remote communication link 8.

For example, the electrical power in that section 1 may remain off at all times, until the attendant 11 turns it on for a particular customer who is old enough to buy the controlled items.

When that particular customer leaves after purchasing what he needs, the vending mechanism of the controlled item section 1 becomes disabled automatically.

Obviously many modifications and variations of the present invention are possible in light of the above teachings. It is therefore to be understood that, within the scope of the appended claims, the invention may be practiced otherwise than as specifically described.

1. A method of selling controlled items requiring age verification through automated vending operation, wherein:
there are a controlled section 1 carrying the controlled items 2 and an open section 3 that carries uncontrolled items in a substantially large scale,
and the vending capability of the controlled section 1 remains disabled unless an attendant 11 located in a remote central monitor office 10 enables the vending capability through a communication link 8,
the communication link 8 carries the image of the customer 9, and the image of an identification card of the customer 9 for verifying his birthdate when age verification is deemed necessary;
and the attendant 11 are responsible for monitoring a plurality of such vending operation sites;
whereby the additional sales from the open section 3 and the sharing of the monitoring expenses among the many vending operation sites make the selling of the controlled items 2 through a vending operation economically feasible.

2. The invention according to claim 1, wherein the control of the vending capability is embodied into the form of a cage 5 with a lock 6 that remains locked unless the attendant 11 unlocks it.

3. The invention according to claim 1, wherein the vending capability is controlled by keeping the vending mechanism disabled unless the attendant enables the vending mechanism.

4. The invention according to claim 1, wherein the vending operation is located in apartment complexes.

5. The invention according to claim 1, wherein the controlled item is cigarettes, cigars, or the likes.
